(19) United States
(12) Patent Application Publication
(10) Pub. No.: US 2009/0174889 A1
(43) Pub. Date: Jul. 9, 2009

(54) METHOD TO PREVENT COUNTERFEIT AND MULTI-FUNCTION PRINTER USING THE SAME METHOD

(75) Inventors: Kyoung-jae LEE, Suwon-si (KR); Sang-hyup Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/328,814

(22) Filed: Dec. 5, 2008

(30) Foreign Application Priority Data
Jan. 7, 2008 (KR) 2008-1694

(51) Int. Cl. G06K 15/02; G06F 3/12

(52) U.S. Cl. 358/1.13; 358/1.14

(57) ABSTRACT

A method of preventing counterfeiting an object document in a multi-function printer, the method includes discriminating the document, determining whether a job on the discriminated document is prohibited, and printing the document of which front and back sides are different in a duplex-printing start position in the case that the job on the document is prohibited.

### CROSS-REFERENCE TO RELATED APPLICATIONS

This application claims priority under 35 U.S.C. §119(a) from Korean Patent Application No. 10-2008-0001694, filed on Jan. 7, 2008 in the Korean Intellectual Property Office, the disclosure of which is incorporated herein in its entirety by reference.

### BACKGROUND OF THE INVENTION

1. Field of the Invention

The present general inventive concept relate to a method of preventing counterfeiting an object document (hereinafter, referred to as a “document”) and a multi-function printer using the same method, and more particularly, to a method of preventing counterfeiting an object document such as paper money or securities and a multi-function printer having a duplex structure to prevent counterfeiting an object document.

2. Description of the Related Art

In general, an image forming apparatus forms a visual image corresponding to provided image data on a print medium. Examples of image forming apparatuses are a printer, a facsimile, a digital copying machine, a multi-function printer, etc. Here, the multi-function printer is capable of performing at least one of printing, scanning, copying and facsimile functions.

As mono and color printing has become popularized, there are increasing counterfeits of paper money and securities. Further, as an electrophotographic image forming apparatus has been improved in performance, distinguishing between a color printed copy and an original become more difficult.

Since distinguishing between the original and the copy becomes harder, there are increasing attempts to counterfeit the original.

### SUMMARY OF THE INVENTION

The present general inventive concept provides a method of preventing counterfeiting an object document such as paper money or securities and a multi-function printer having a duplex structure to prevent counterfeiting an object document.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing a method of preventing counterfeiting an object document in a multi-function printer, the method comprising discriminating the document, determining whether a job on the discriminated document is prohibited, and printing the document of which front and back sides are different in a duplex-printing start position in the case that the job on the document is prohibited.

The method may further comprise receiving an input data corresponding to the document.

The input data may be obtained by either of reading the document or being received from an external device connected to the multi-function printer.

The document may comprise at least one of paper money and securities.

The prohibited-job may comprise at least one of copying and printing.

The printing may comprise offset printing.

The offset printing may have a variable offset value.

The printing may comprise disposing the printing start positions randomly in the state that the front and back sides are overlapped with each other.

The method may further comprise displaying determination results to a user in case of the prohibited-job.

The displaying the determination results may comprise displaying the determination results through at least one of user interfaces (UI) of a control panel provided in the multi-function printer and a host system connected with the multi-function printer.

The foregoing and/or other aspects and utilities of the present general inventive concept can also be achieved by providing a multi-function printer comprising a scanning portion to scan an object document, a document discriminator to discriminate the document transmitted from the scanning portion, a prohibited-job determiner to determine whether a job on the document is prohibited, an image forming portion to print the document, and a controller to control the image forming portion to print the document of which front and back sides are different in a duplex-printing start position in the case that the job on the document is prohibited.

The multi-function printer may further comprise a control panel comprising a display portion and a plurality of buttons, wherein the controller controls the display portion to display determination results from the prohibited-job determiner.

The multi-function printer may further comprise an interface to be connected with an external device, wherein the multi-function printer connects and communicates with at least one of a host system and a portable storage through the interface.

The controller may control the image forming portion to print the document by changing offset values of the duplex-printing start positions for the front and back sides of the document.

The controller may control the image forming portion to print the document with random printing start positions in the state that the front and back sides of the document are overlapped with each other.

The plurality of buttons may be used to change the offset values.

The foregoing and/or other aspects and utilities of the present general inventive concept can also be achieved by providing a multi-function printer including an image forming portion having an offset duplex print mode to print a copy of an object document in duplex in which a front image and a back image thereof are offset and a non-offset duplex print mode in which the front image and the back image thereof are not offset, and a controller to select one of the offset duplex print mode and the non-offset duplex print mode based on a determination of whether printing the copy of the object document is restricted.

A duplex-printing start position of a front side of the copy of the front image and a back side of the copy of the back image may be different in the offset duplex print mode.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a block diagram illustrating a multi-function printer according to an exemplary embodiment of the present general inventive concept;

FIG. 2 is a cross-section view illustrating the multi-function printer according to an exemplary embodiment of the present general inventive concept;

FIG. 3 is a flowchart of a method to prevent counterfeiting an object document according to an exemplary embodiment of the present general inventive concept;

FIGS. 4 and 5 illustrate printing results from prohibited-job determined according to the method of FIG. 3; and

FIGS. 6 and 7 illustrate examples of user interfaces displayed according to the method of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

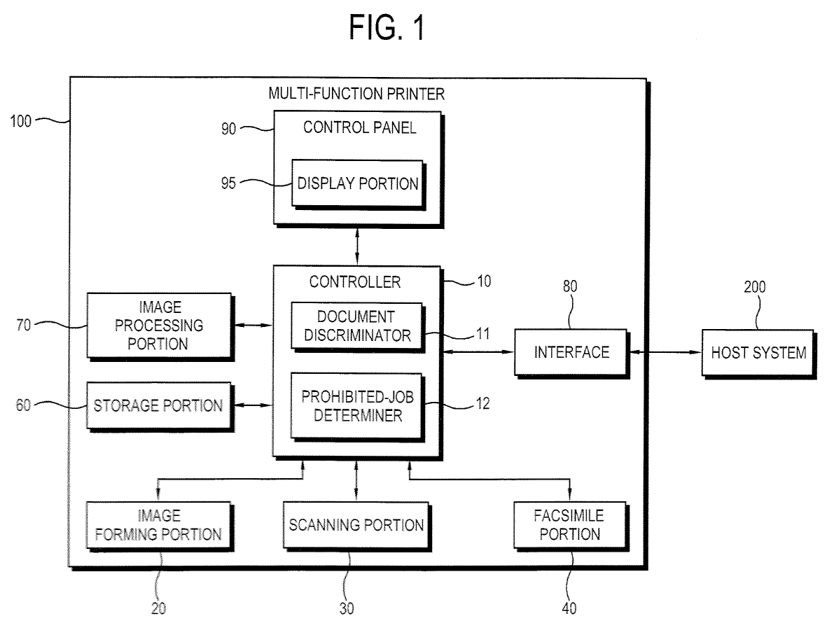

FIG. 1 is a block diagram illustrating a multi-function printer according to an exemplary embodiment of the present general inventive concept. In this embodiment, a multi-function printer 100 has a duplex function to print both sides, i.e., front and back sides of a document or the like copy on the both sides of a print medium, respectively (hereinafter, it will be referred to as a “duplex printing”).

According to an exemplary embodiment of the present general inventive concept, the multi-function printer 100 includes a controller 10 to perform general control of elements; an image forming portion 20 to print an image, a scanning portion 30, a document discriminator 11, and a prohibited-job determiner 12. The multi-function printer 100 may employ a local port such as a serial bus, a parallel bus, etc., or a network port to transmit data to and receive the data from a host system 200, or include an interface 80 to be connectable with a portable mass storage (not illustrated). Further, the multi-function printer 100 includes a control panel 90 provided with control buttons to manipulate a display portion 95 that displays a current operation, an error or the like; number keys to input a phone number; etc. Also, the multi-function printer 100 may further include a facsimile portion 40 to perform facsimile functions. In addition, the multi-function printer 100 may include a storage portion 60 to store scanning data scanned through the scanning portion 30; printing data to be printed by the image forming portion 20; facsimile data scanned through the scanning portion 30 so as to be transmitted through the facsimile portion 40; parameters to control the multi-function printer 100; etc. The storage portion 60 may be provided in the multi-function printer 100, or at least one of the portable mass storage (not illustrated) and the host system 200 which are connectable with the multi-function printer 100. The host system 200 may include a server or personal computer to control the multi-function printer 100. Further, the storage portion 60 may be realized as a volatile memory or a non-volatile memory such as a hard disk drive (HDD), and have a file system to manage the stored files.

Also, the storage portion 60 may store job data to be processed by the scanning portion 30, the image forming portion 20 and the facsimile portion 40.

Further, the storage portion 60 may store data for reservations performed by at least one of the facsimile portion 40 and the image forming portion 30. Further, the multi-function printer 100 may include an image processing portion 70 to process the data scanned through the scanning portion 30 or the printing data received from the host system 200.

The document discriminator 11 discriminates a type of an object document which may be scanned through the scanning portion 30 or received from the host system 200 or the like outside of the multi-function printer 100. For example, the document discriminator 11 determines whether the document is real money, i.e., real currency. The real currency includes at least one of paper money and securities. The prohibited-job determiner 12 determines whether a job such as copying or printing on the document is allowed or prohibited on a basis of the discrimination result from the document discriminator 11. As illustrated in FIG. 1, the document discriminator 11 and the prohibited-job determiner 12 may be provided in the controller 10. In this case, the controller 10 including the document discriminator 11 and the prohibited-job determiner 12 may include a non-volatile memory (not illustrated) such as a read only memory (ROM) in which a program corresponding to operations of the document discriminator 11 and the prohibited-job determiner 12 is stored; a volatile memory (not illustrated) such as a random access memory (RAM) in which the program stored in the non-volatile memory is loaded; and a processor (not illustrated) such as a central processing unit (CPU) which executes the program loaded to the volatile memory. Alternatively, all or a portion of the document discriminator 11 and the prohibited-job determiner 12 may be provided independently of the controller 10.

The controller 10 controls the image forming portion 20 and the image processing portion 70 on a basis of the determination results from the prohibited-job determiner 12 so that both sides of the document are printed at different printing start positions from each other. Detailed operations of the controller 10, the image forming portion 20, the scanning portion 30, etc., will be described later.

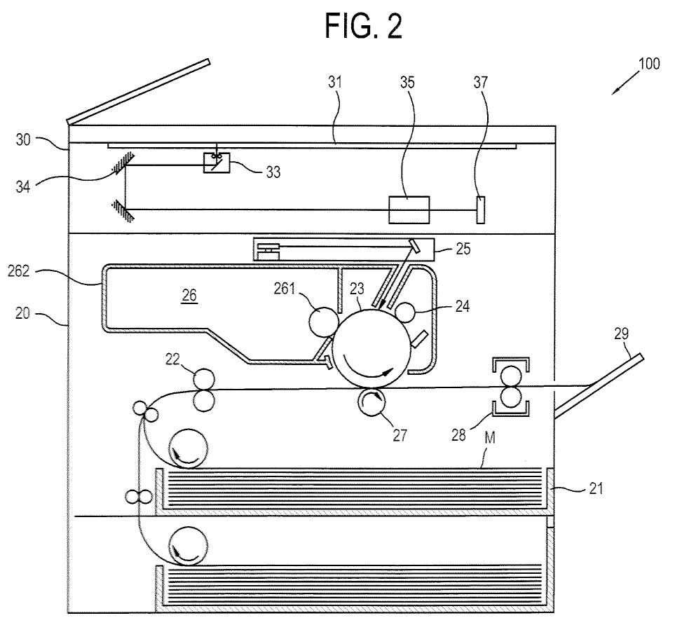

FIG. 2 is a cross-section view of the multi-function printer 100 according to an exemplary embodiment of the present general inventive concept. Below, descriptions about other configurations of the multi-function printer 100 except the image forming portion 20 and the scanning portion 30 will be omitted.

Referring to FIG. 2, the image forming portion 20 prints an image on a print medium M in an electrophotographic manner. The image forming portion 20 includes a medium tray 21 in which the print medium M is stacked, and a medium feeding unit 22 to feed the print medium M. Further, the image forming portion 20 includes a photosensitive body 23, an electric charger 24, an exposure unit 25, a developing unit 26, a transferring unit 27 and a fusing unit 28.

With this configuration, the image forming portion 20 forms an image as follows. First, the electric charger 24 charges the photosensitive body 23 with a predetermined electric potential uniformly. Then, the exposure unit 25 emits light corresponding to image data to the photosensitive body 23, and a portion exposed to the light in the photosensitive body 23 is lowered in the electric potential, thereby forming a latent image on a surface of the photosensitive body 23. Then, a developing bias is applied to a developing roller 261 of the developing unit 26, so that a toner filled in a toner chamber 262 of the developing unit 26 can be attached to the latent image, thereby forming a toner image.

Further, the print medium M fed from the medium tray 21 arrives at a transferring nip (not illustrated) when an end of the toner image formed on the photosensitive body 23 arrives at the transferring nip facing the transferring unit 27. Thus, when a transferring bias is applied to the transferring unit 27, the toner image is transferred from the photosensitive body 23 to the print medium M. Then, while the print medium M to which the toner image is transferred passes through the fusing unit 28, the toner image is fixed on the print medium M by heat and pressure, thereby completing the printing of the image. In addition, the image forming unit 20 includes a medium ejecting unit 29 to eject the print medium M out when the printing for this print medium M is completed.

According to an exemplary embodiment of the present general inventive concept, the image forming portion 20 may use an inkjet operation instead of the electrophotographic operation to form an image. If the image forming portion 20 use the inkjet operation, the image forming portion 20 may include a cartridge (not illustrated) having an inkjet head, a carriage (not illustrated) to move the cartridge, and a carriage driver (not illustrated), which are well known so that detailed descriptions thereof will be avoided.

The scanning portion 30 includes a document table where a document is put on, an illuminator 33 to emit light to the document table 31, a focusing lens 35, and a sensor 37 to read image data about the document on a basis of light reflected from the document on the document table 31. Thus, the light emitted from the illuminator 33 to the document table 31 is reflected from the document, and focused on the sensor 37 through the focusing lens 35. The sensor 37 reads the data from the document on a basis of the focused light.

Further, the scanning portion 30 may include a plurality of reflecting mirrors 34 placed between the document and the focusing lens 35. The plurality of reflecting mirrors 34 are provided to secure an optical path within a limited space, and change the optical path by reflecting the light reflected from the document the document.

Such operations of the image forming portion 20 and the scanning portion 30 may be controlled by the controller 10.

Below, the method of preventing counterfeiting an object document such as paper money or securities and the multi-function printer 100 having a duplex structure to prevent counterfeiting an object document will be described with reference to FIGS. 1 through 7.

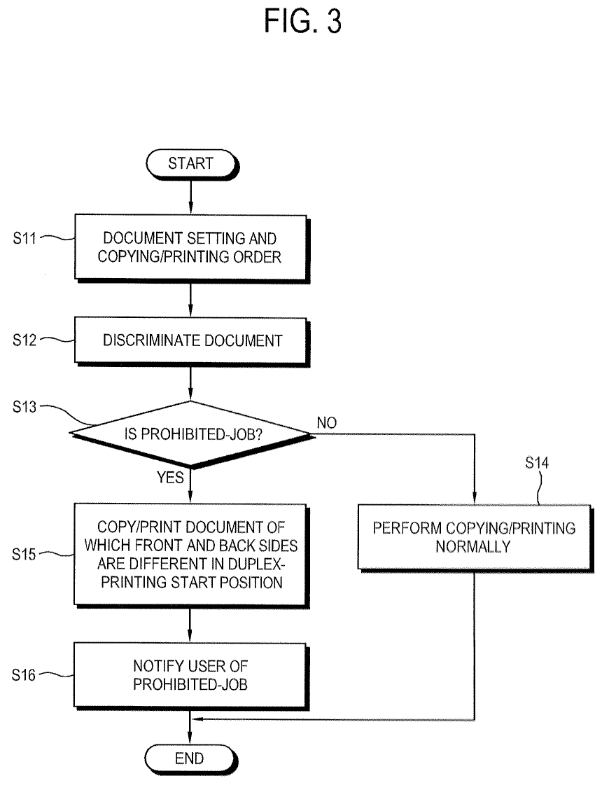

FIG. 3 is a flowchart illustrating a method to prevent counterfeiting an object document according to an exemplary embodiment of the present general inventive concept, in which the method may be achieved by the multi-function printer 100 illustrated in FIGS. 1 and 2.

First, at operation S11, an object document to be copied is set on the document table 31 illustrated in FIG. 2, and a copying order for copying the document is given through the control panel 90 illustrated in FIG. 1.

Alternatively, at the operation S11, the object document may be received from the outside of the multi-function printer 100 such as a mass storage (not illustrated), a host system 200, or the like. In this case, a job on the document may include a printing job for the document received from the outside. In the operation S11, the copying and printing job may include automatic printing to be applied to both sides of the document.

Then, at operation S12, a type of document set on the document table 31 is discriminated. In this case, if the document is received from the outside of the multi-function printer 100, the discrimination is applied to the document received from the outside. In the operation S12, the document discriminator 11 discriminates the type of document and transmits the discrimination results to the prohibited-job determiner 12 (refer to FIG. 1).

At operation S13, the prohibited-job determiner 12 determines whether a current job on the document is allowed or prohibited (that is, restricted) on a basis of the discrimination results from the document discriminator 11. For example, the prohibited-job determiner 12 determines that the current job is prohibited if the document is discriminated as the real money, i.e., the real currency.

If a determination is made at the operation S13 that the current job is allowed, i.e., in case of a normal copying or printing job, at operation S14 the controller 10 controls the image forming portion 20 and the scanning portion 30 to normally copy or print the document.

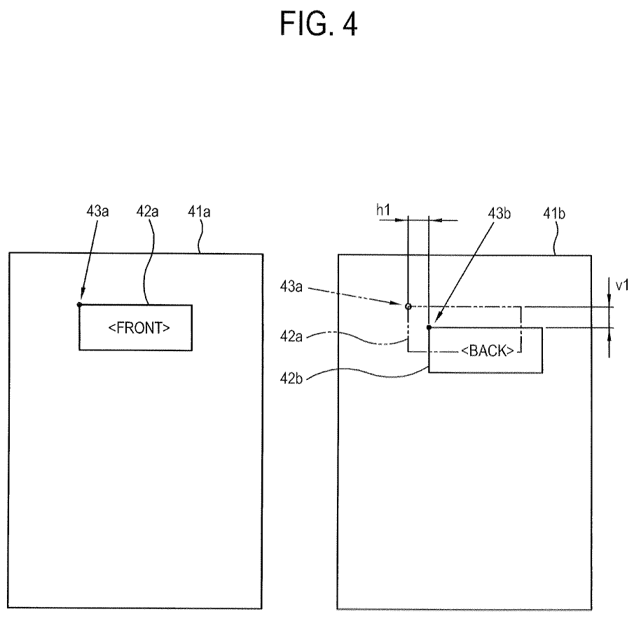

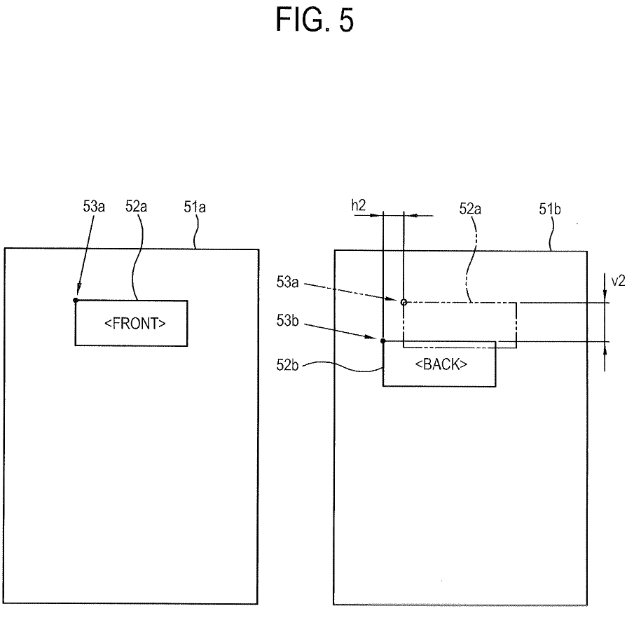

If a determination is made at operation S15 that the current job is prohibited, the controller 10 controls the image processing portion 70 and the image forming portion 20 to copy or print the front and back sides of the document at different printing start positions from each other. Below, the operation S15 will be described in more detail with reference to FIGS. 4 and 5.

FIG. 4 illustrates printing results from the prohibited-job determined according to an exemplary embodiment of the present general inventive concept. In FIG. 4, the reference numerals 41a and 41b indicate front and back sides of the print medium such as paper or the like, respectively. Further, the reference numerals 42a and 42b indicate front and back images of the document which are printed on the front and back sides of the print medium, respectively. Also, the reference numerals 43a and 43b indicate the printing start positions of the front and back images 42a and 42b of the document, respectively. In this embodiment, the printing start positions 43a and 43b are set as top left corners of the front and second images 42a and 42b, respectively. However, such a reference position for the copying or printing is not limited to the top left corner. Alternatively, the reference position may be set as a voluntary position on the print image or a voluntary position on the print medium from the print image.

As illustrated in FIG. 4, in the case of the prohibited-job, the controller 10 controls the front image 42a to be printed at the normal printing start position 43a but controls the printing start position 43b of the back image 42b not to be aligned with the printing start position 43a of the front image 42a. Here, the controller 10 changes an offset value for the printing start positions 43a and 43b of the front and back images 42a and 42b of the document, thereby making the printing start positions 43a and 43b different from each other.

In this embodiment, the back image 42b is placed from a right bottom of the front image 42a in order to get misalignment between the front image 42a and the back image 42b, but not limited thereto. Alternatively, the back image 42b may be placed from a right top, a left top, a left bottom, and so on of the front image 42a as long as the front image 42a and the back image 42b are not aligned with each other.

In FIG. 4, the reference numerals of h1 and v1 indicate breadthwise and lengthwise offsets between the printing start positions 43a and 43b of the front and second images 42a and 42b, respectively. The breadthwise offset h1 and the lengthwise offset v1 may have sizes of 30 mm and 10 mm, respectively. The sizes of the breadthwise and lengthwise offsets h1 and v1 may be preset while designing the multi-function printer, or may be set and/or changed by a user.

According to another embodiment of the present general inventive concept, in the case of the prohibited-job, the controller 10 may control the back image 42b to be printed at the normal printing start position 43b but control the printing start position 43a of the front image 42a not to be aligned with the printing start position 43b of the back image 42b. According to still another embodiment of the present general inventive concept, in the case of the prohibited-job, the controller 10 may control both the front and back images 42a and 42b of the document to be printed at the abnormal printing start positions 43a and 43b so that the front and back images 42a and 42b can be misaligned with each other.

FIG. 5 is illustrates printing results from the prohibited-job determined according to another exemplary embodiment of the present general inventive concept. With regard to this embodiment illustrated in FIG. 5, the same or similar elements as those of FIG. 4 will be omitted.

In FIG. 5, the reference numerals of 51a and 51b indicate front and back sides of the print medium such as paper or the like, respectively. Further, the reference numerals of 52a and 52b indicate front and back images of the document which are printed on the front and back sides of the print medium, respectively. Also, the reference numerals of 53a and 53b indicate the printing start positions of the front and back images 52a and 52b of the document, respectively. In addition, the reference numerals of h2 and v2 indicate breadthwise and lengthwise offsets between the printing start positions 53a and 53b of the front and second images 52a and 52b, respectively.

Referring to FIG. 5, in the case of the prohibited-job, the controller 10 controls the breadthwise offset h2 and the lengthwise offset v2 to have random sizes so that the printing start position 53a of the front image 52a can be misaligned with the printing start position 53b of the back image 52b.

In this case, the sizes of the breadthwise offset h2 and the lengthwise offset v2 may be arbitrarily set within a predetermined range. For example, the sizes of the breadthwise offset h2 and the lengthwise offset v2 may be arbitrarily set within a range from 10 to 50 mm and a range from 10 to 30 mm, respectively. The ranges of the breadthwise and lengthwise offsets h2 and v2 may be set so that the front and back images 52a and 52b of the document can be at least partially overlapped with each other. The ranges of the breadthwise and lengthwise offsets h2 and v2 may be preset while designing the multi-function printer, or may be set and/or changed by a user.

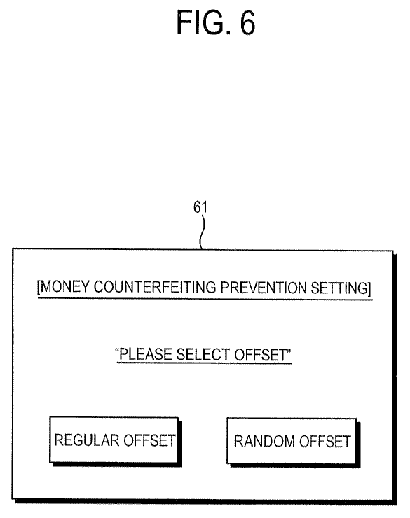

For the misalignment between the printing start positions of the front and back images of the document, a user may select whether to apply the regular offsets illustrated in FIG. 4 or the random offsets illustrated in FIG. 5. In this case, as illustrated in FIG. 6, the controller 10 may display a user interface 61 for a user's selection through the display portion 95 of the display panel 90 and/or a display (not illustrated) of the host system 200.

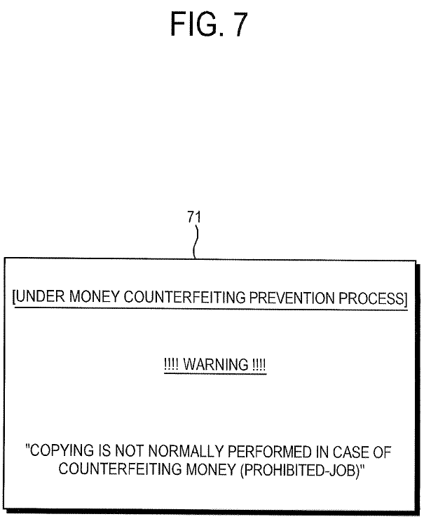

Referring back to FIG. 3, when the operation S15 is completed, operation S16 may be selectively performed. At the operation S16, the controller 10 displays a user interface 71 (refer to FIG. 7) through the display portion 95 of the display panel 90 and/or the display (not illustrated) of the host system 200, thereby warning a user that the current job on the document is prohibited and notifying a user that the copying is not normally performed.

As described above, the present embodiment provides a method of preventing counterfeiting an object document and a multi-function printer using the same method, so that paper money or securities can be prevented from being counterfeit through the foregoing method and multi-function printer.

Further, according to various embodiments of the present general inventive concept, the document such as paper money or securities is printed with the misaligned printing start position without corrupting the original image, so that the paper money or securities can be used without a loss of image quality in the case where the copying/printing results are not abused but used with good intent, e.g., an exhibition.

Although a few exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of preventing counterfeiting an object document in a multi-function printer, the method comprising:
discriminating the document;
determining whether a job on the discriminated document is prohibited; and
printing the document of which front and back sides are different in a duplex-printing start position in the case that the job on the document is prohibited.

2. The method according to claim 1, further comprising:
receiving an input data corresponding to the document.

3. The method according to claim 2, wherein the input data is obtained by either of reading the document or being received from an external device connected to the multi-function printer.

4. The method according to claim 1, wherein the document comprises:
at least one of paper money and securities.

5. The method according to claim 1, wherein the prohibited-job comprises:
at least one of copying and printing.

6. The method according to claim 1, wherein the printing comprises:
offset printing.

7. The method according to claim 6, wherein the offset printing has a variable offset value.

8. The method according to claim 1, wherein the printing comprising:
disposing the printing start positions randomly in a state that the front and back sides are overlapped with each other.

9. The method according to claim 1, further comprising:
displaying determination results to a user in case of the prohibited-job.

10. The method according to claim 7, wherein the displaying the determination results comprises:
displaying the determination results through at least one of user interfaces (UI) of a control panel provided in the multi-function printer and a host system connected with the multi-function printer.

11. A multi-function printer, comprising:
a scanning portion to scan an object document;
a document discriminator to discriminate the document transmitted from the scanning portion;
a prohibited-job determiner to determine whether a job on the document is prohibited;
an image forming portion to print the document; and
a controller to control the image forming portion to print the document of which front and back sides are different in a duplex-printing start position in the case that the job on the document is prohibited.

12. The multi-function printer according to claim 11, further comprising:
a control panel comprising a display portion and a plurality of buttons,
wherein the controller controls the display portion to display determination results from the prohibited-job determiner.

13. The multi-function printer according to claim 12, further comprising an interface to be connected with an external device,
wherein the multi-function printer connects and communicates with at least one of a host system and a portable storage through the interface.

14. The multi-function printer according to claim 11, wherein the controller controls the image forming portion to print the document by changing offset values of the duplex-printing start positions for the front and back sides of the document.

15. The multi-function printer according to claim 11, wherein the controller controls the image forming portion to print the document with random printing start positions in the state that the front and back sides of the document are overlapped with each other.

16. The multi-function printer according to claim 15, wherein the plurality of buttons are used to change the offset values.

17. A multi-function printer, comprising:
an image forming portion having an offset duplex print mode to print a copy of an object document in duplex in which a front image and a back image thereof are offset and a non-offset duplex print mode in which the front image and the back image thereof are not offset; and
a controller to select one of the offset duplex print mode and the non-offset duplex print mode based on a determination of whether printing the copy of the object document is restricted.

18. The multi-function printer according to claim 17, wherein a duplex-printing start position of a front side of the copy of the front image and a back side of the copy of the back image are different in the offset duplex print mode.
